(19) United States
(12) Patent Application Publication
(10) Pub. No.: US 2003/0035074 A1
(43) Pub. Date: Feb. 20, 2003

(54) Remote control device having a display for displaying a television channel guide

(76) Inventors: Thomas James Dubil, Morgan Hill, CA (US); Stuart McKechnie, San Jose, CA (US)

Correspondence Address: U.S. Philips Corporation, 580 White Plains Road, Tarrytown, NY, 10591, US

(21) Appl. No.: 09/932,072

(22) Filed: Aug. 17, 2001

(51) Int. Cl. G06F 3/00; H04N 5/445; G06F 13/00; H04N 7/00; H04N 5/44

(52) U.S. Cl. 348/734; 725/38; 725/37

(57) ABSTRACT

A remote control device is provided for a television which enables a user to determine what programs are being aired or scheduled to air without disrupting a program currently being watched. The remote control device includes a display, e.g., a graphical user interface, for displaying a television channel guide listing the various programs currently being aired. Preferably, the display is a touch screen or includes directional cursor control for selecting a desired program by touching the desired program listing on the display or situating a cursor over the desired program listing and performing an action, such as clicking a “SELECT” button. The remote control device also includes a conventional user-interface with multiple user inputs for selective control of a particular one of the functionalities of the television through sending a particular one of multiple control signals to the television. The remote control device receives the television channel guide by various means, such as an RF link or a direct connection to an Internet connected host, such as a set top box or a personal computer, an RF link to a remote central station which broadcasts an RF modulated signal which includes the television channel guide, or via a set top box receiving a broadcast signal having an electronic program guide (EPG) therein.

### BACKGROUND OF THE INVENTION

1. Technical Field

The present disclosure relates generally to a remote control device having a display for displaying a television channel guide for allowing a user to determine what programs are being aired or scheduled to air without disrupting a program currently being watched.

2. Background of the Related Art

A well known example of a remote control device is the hand held remote controller for control of consumer audio and video equipment. The controller communicates control signals according to the particular user-input activated device. The majority of modem wireless remote control devices use an infra-red (IR) pulse command code modulated carrier to send the control signals.

One of the most widely used remote control devices is a remote control device for controlling a television. A user typically uses such a remote control device to flip through the various channels to locate a desirable program to watch or to determine what other programs are currently being aired as the desirable program or are scheduled to air. To achieve any of these two purposes, the user may opt to select a television guide channel displaying a channel guide of the various programs currently being aired or scheduled to air for each channel. This means that if a desirable program is being watched, the user will disrupt that program upon selecting the television guide channel or upon flipping through the various channels.

A need therefore exists for a remote control device for a television which enables the user to determine what programs are being aired or scheduled to air without disrupting a program currently being watched.

### SUMMARY OF THE INVENTION

The present disclosure provides a remote control device for a television which enables a user to determine what programs are being aired or scheduled to air without disrupting a program currently being watched. The remote control device of the present disclosure includes a display, e.g., a graphical user interface, for displaying a television channel guide listing the various programs currently being aired. Preferably, the display is a touch screen or includes directional cursor control for selecting a desired program by touching the desired program listing on the display or situating a cursor over the desired program listing and performing an action, such as clicking a “SELECT” button. The remote control device also includes a conventional userinterface with multiple user inputs for selective control of a particular one of the functionalities of the television through sending a particular one of multiple control signals to the television.

The remote control device receives the television channel guide by various means, such as an RF link or a direct connection to an Internet connected host, such as a set top box or a personal computer, an RF link to a remote central station which broadcasts an RF modulated signal which includes the television channel guide, or via a set top box receiving a broadcast signal having an electronic program guide (EPG) therein. The television channel guide may also be received by the remote control device in the form of XML; a structured manner of presenting data with XSL to simulate HTML.

### BRIEF DESCRIPTION OF THE DRAWINGS

The invention is further explained by way of example and with reference to the accompanying drawings, wherein:

FIG. 1 is a perspective view of a remote control device having a display for displaying a television channel guide according to the present invention; and

FIG. 2 is a system showing transmittal of an RF modulated signal to the remote control device of FIG. 1.

### DETAILED DESCRIPTION OF PREFERRED EMBODIMENTS

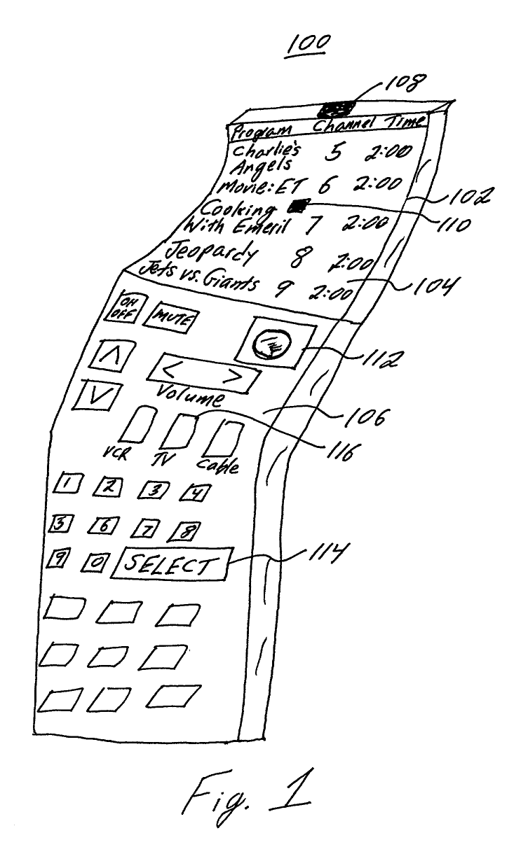

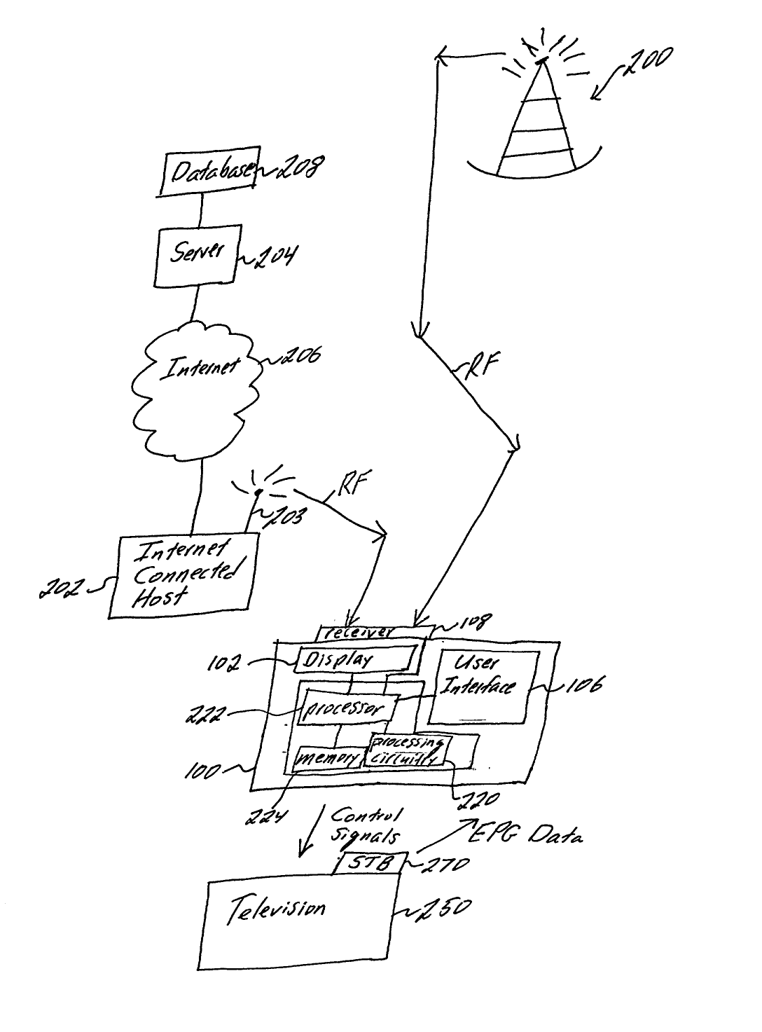

FIG. 1 is a perspective view of a remote control device designated generally by reference numeral 100 which includes a display 102 for displaying a television channel guide 104 according to an embodiment of the present invention. The remote control device 100 is preferably designed as a universal remote control device for controlling a home entertainment system which includes a television. The television 250 (see FIG. 2) has multiple functionalities that are user-controllable by the remote control device 100, e.g., “TV-on/off”, “channel up/down”, “mute”, “brightness up”, etc.

The remote control device 100 further includes a user-interface 106 with multiple user-inputs (e.g., buttons, or soft keys on a GUI). The multiple user-inputs provide selective conrol of a particular one of the multiple functionalities of the televison or any other apparatus of the home entertainment system by sending a particular one of multiple control signals. The disclosure herein, however, is not limited to a consumer environment.

The remote control device 100 of the embodiment of FIG. 1 further includes an RF receiver and transmitter (transceiver) 108 for receiving an RF modulated signal which includes the television channel guide 104 from a remote central station 200 or an Internet connected host 202 (see FIG. 2), such as a set top box or a personal computer. The set top box or PC has standard signal processing components to convert a digital signal containing Internet content to an RF modulated signal and to transmit the RF modulated signal to the remote control device 100. It is contemplated that the remote central station continuously or intermittently transmits the RF modulated signal.

Upon being received by the receiver 108 of the remote control device 100, the RF signal is processed using conventional processing circuitry 220 (see FIG. 2, where internal components of the remote control device 100 are depicted) to retrieve the television channel guide 104. The television channel guide 104 listing the various programs currently being aired or scheduled to air in the near future is then displayed on the display 102 of the remote control device 100.

The television channel guide 104 may also be received by the remote control device 100 in the form of XML. XML is emerging as the universal format for structured documents and data on the World Wide Web. XML makes it relatively straightforward to define new document types, to author and manage documents and to transmit and share the documents across the Internet. XSL is used for defining style sheets, and provides a language for translating XML documents and an XML vocabulary. XSL specifies the formatting of semantics. Information in XML format on the World Wide Web can be transformed in a presentation format such as HTML, WML or SMIL with XSL style sheets. This separation of semantics and presentation makes possible platform customization and user personalization of World Wide Web content. In an XSL transformation, an XSL processor or application reads an XML document and an XSL style sheet. Based on the instructions in the XSL style sheet, the XSL processor or application supplies a new XML, HTML or otherwise formatted document.

An XML application, such as an XSL style sheet, at the receiving end, operates on the data under control of instructions in the style sheet. This application is used, for example, for control of generating the proper IR or RF commands based on the received data and for generating a GUI as an, e.g., HTML page on a suitable display.

The XML data can also contain control codes associated with the content in order to enable user interaction with a remote device, such as the television 250 or a video cassette recorder, for channel navigation, content recording, etc. The XML data may also contain a Java applet, i.e., a script, e.g., JScript, JavaScript, and VBScript, to provide greater flexibility for GUI presentation and device control. In a home networking environment, e.g., UPnP, HAVi, Jini and others, the remote control device 100 can act as a control point for a set top box, television, recording equipment and other network devices. The XML data can also contain data relating to current or future content available through the television 250 or other device.

For example, a set top box based application can compose an XML or HTML page that can be accessed by the remote control device 100. The set top box acts as an HTTP server to present the content information (the television channel guide 104) and navigation control to the user via the remote control device 100. The remote control device 100 receives the page automatically or per user request. The pages can be customized for individual family members, e.g. children shows, sports events, soap operas and etc.

The television channel guide 104 may be displayed in any particular display format. Preferably, the individual television programs of the television channel guide 104 are displayed numerically according to their respective channel numbers and time of airing and are scrolled from bottom to top of the display 102. Preferably, shows to be aired in the near future are displayed when their scheduled air time is approximately less than fifteen minutes in the future.

Preferably, the display 102 is a touch screen or includes directional cursor control for selecting a desired program listed by the television channel guide 104 by touching the desired program listing on the display 102 or situating a cursor 110 using a roller-ball 112 over the desired program listing and performing an action, such as clicking a “SELECT” button 114 on the user-interface 106 of the remote control device 100. Upon touching the touch screen or performing another action to indicate selection of the desired program, i.e., the program corresponding to the desired program listing, the remote control device 100 formats a signal that is compatible with the television that includes the selected channel and transmits the signal to the television to tune to the channel airing the desired program.

If the desired program is scheduled to air in the near future, a processor 222 (see FIG. 2) within the remote control device 100 stores the time the desired program is scheduled to air and the corresponding channel within a memory 224. When an internal clock of the processor 222 matches the stored time, the processor 222 sends a signal to the RF receiver 108 to transmit a signal to the television to tune to the channel airing the desired program.

It is contemplated that the memory 224 of the remote control device 100 can store a plurality of scheduled air times and corresponding channels to tune the television to these channels at the scheduled air times. It is further contemplated that if a desired program scheduled to air is selected from the television channel guide 104 and the scheduled air time of the desired program matches a stored scheduled air time of a previously selected desired program, then the corresponding channel of the most recently selected desired program is stored to correspond to the stored scheduled air time. In other words, the previously stored channel is over-written in the memory 224 with the channel corresponding to the most recently selected desired program.

The remote control device 100 has stored signal codes that can control more than one television using a TV manual select button 116 to switch between two or more televisions. For example, when the TV manual select button 116 is pressed one time, television A can be controlled, and when the TV manual select button 116 is pressed two times, television B can be controlled until the TV manual select button 116 is pressed again.

With reference to FIG. 2, there is shown a system showing transmittal of the RF modulated signal to the remote control device 100 capable of controlling the television 250 by transmitting control signals. The RF modulated signal can either be transmitted from the remote central station 200 or the Internet connected host 202 which can be a set top box or a personal computer. The set top box or personal computer are provided with processing circuitry to convert the digital signal to an RF signal and an antenna 203 for transmitting the RF modulated signal to the remote control device 100.

Preferably, the Internet connected host 202 is connected to a remote server 204 via the Internet 206 or other network. The remote server 204 has access to a database 208 which stores the television channel guide 104. The remote server 204 thus transmits the television channel guide 104 via the Internet 206 to the Internet connected host 202. As noted, the Internet connected host 202 includes processing circuitry, as known in the art, for converting the received television channel guide 104 from a digital format to the RF modulated signal for transmission to the remote control device 100 via an antenna 203.

The remote server 204 can be accessed by a user through the use of a conventional web browser. The user can type the URL corresponding to the remote server 204 on the web browser and press “ENTER”. The user will then access a web site corresponding to the URL for subscribing to the system, for reconfiguring the format the television channel guide 104 is provided, for authorizing the transmission of the television channel guide 104 to the Internet connected host 202, etc.

It is contemplated that the remote control device 100 includes an Internet connection capability, i.e., the remote control device 100 includes at least a web browser and a wireless modem for connecting to the Internet. The user can then use a keyboard of the remote control device 100 for typing the URL corresponding to the remote server 204. Accordingly, the user can access the web site corresponding to the URL with the remote control device 100 and subscribe to the system, as well as perform other tasks, without having to use the Internet connected host 202.

It is also contemplated to program the processor 222 of the remote control device 100 with a set of instructions in order for the remote control device 100 to be able to control other consumer electronic appliances and systems, besides the television 250, such as a microwave, stereo system, radio, satellite television system, Internet radio, alarm system, etc. In this regard, it is contemplated for the remote control device 100 to be used to connect to the Internet, as described above, and then to access a particular web site or the same web site described above. The user can then select an electronic appliance and a corresponding model number from the web site which correspond to the electronic appliance the user wants to control.

Upon selecting the electronic appliance and corresponding model number, the user is then presented with a scrolling list of functions on the display 102. These list of functions are preferably stored within the database 208 or another database, along with their corresponding electronic appliance and model number, and are accessed via the remote server 204 or another remote server before they are made available to the user. The user can then select a particular function, e.g., turn stereo system on, to transmit a signal to the electronic appliance in order to control the electronic appliance, as described above with respect to controlling the television 250. The user can then select other sub-functions to further control the electronic appliance, e.g., tune stereo system to a particular AM/FM channel, play a CD, etc.

As further illustrated by FIG. 2, the television channel guide 104 can also be received as an electronic program guide (EPG), which is typically supplied via a set top box 270 and conventionally displayed on a television's display monitor. Instead of displaying the EPG data on the television's display monitor, the EPG data is exported from the set top box 270 to the remote control device 100 via a wireless, e.g., as an RF signal, or non-wireless link and displayed on the remote control device's display 102. The EPG data is preferably embedded within a broadcast signal capable of being received by the set top box 270.

It is contemplated to present the EPG data on the device's touch screen as a grid with columns defining the time slots and rows defining the channels. An intersection of a specific row with a specific column has a field that shows information about the program broadcast on that channel within that time slot. The grid can be fairly large compared to the size and resolution of the remote control device's display 102.

An ergonomic manner of presenting the information to the user is described in copending U.S. patent application Ser. No. 09/619,426 filed on Jul. 19, 2000 and titled, “Hand-held with Auto-zoom For Graphical Display of Web Page.” This document describes a feature called “auto-zoom”. The auto-zoom feature is relevant to the rendering of any kind of graphical information on a display too small for the total information content, given the display's resolution and size. For example, handheld information processing devices with Internet access (web browsers) and displays, such as PDAs, web pads, and mobile phones using, e.g., the WAP (wireless application protocol) technology, etc., can be provided with browsers for retrieving and navigating web pages from the Internet, but they cannot render a page in its entirety without losing information. Such handheld devices provided with the auto-zoom feature allows the content on the display 102 to be zoomed in and out.

Accordingly, it is contemplated to provide the auto-zoom feature within the remote control device 100 for zooming in and out the EPG data or other data. It is also contemplated for the display 102 to be operative in enabling the user to select via the touch screen a portion of the image when displayed at a first scale. Upon the portion being selected, the remote control device 100 renders the selected portion on the display 102 at a second scale which is larger than the first scale (zoom-in). The portion selected corresponds to a location on the touch screen.

The remote control device 100 receives the EPG data wirelessly as an RF signal via the receiver 108 and preferably converts the EPG data to digital data using the processing circuitry 220. The EPG data is then displayed on the display 102. The EPG data can also be received non-wirelessly as digital data or other format. The user can then select the channel and/or television program desired as described above, i.e., using a touch screen, a directional cursor control system, etc.

It is contemplated that the EPG data is displayed on the display 102 when an “EPG Button” on the user interface 106 is pressed. It is also contemplated to display the EPG data upon pressing a television channel on the touch screen which corresponds to the television channel that shows the EPG data. Accordingly, instead of the television switching channels to the channel that shows the EPG data, the EPG data is displayed on the remote control device's display 102. It is also contemplated for the receiver 108, which is a transceiver as indicated above, to communicate wirelessly with the set top box 270 or another processing device for receiving the EPG data. Accordingly, the set top box 270 can be instructed by the remote control device 100 to exclude certain channels or unused channels.

It is further contemplated for the set top box 270 which receives the EPG data to convert the EPG data into a particular format, such XML, HTML, HomeRF, IP, BlueTooth, 802.11, etc., before transmitting the EPG data to the remote control device 100. Further still, it is contemplated for the remote control device 100 to be equipped with a removable media interface, e.g., FlashCard, PCMCIA, etc., for providing wireless communication capabilities to the remote control device 100. For example, to convert the EPG data received from the set top box 270 into a format acceptable to the remote control device 100.

A service provider operates the remote central station 200, the same or a different service provider operates the remote server 204 and database 208, and the same or a different service provider operates the broadcasting facility which transmits the EPG data to the set top box 270. It is contemplated that the service provider bills subscribers at regular intervals for the service of providing the television channel guide 104.

Accordingly, with the remote control device 100 of the present invention, a user is able to determine what programs are being aired or scheduled to air without disrupting a program currently being watched.

It will be understood that various modifications may be made to the embodiments disclosed herein and that the above description should not be construed as limiting, but merely as exemplifications of preferred embodiments. For example, the television channel guide 104 may be received by the remote control device 100 via a direct connection to an Internet connected host or a telephone jack connected to the public switched telephone network (PSTN). Further, the remote control device 100 of the present disclosure may be designed to operate by using other type of signals besides RF signals, such as infrared signals. Accordingly, those skilled in the art will envision other modifications within the scope and spirit of the claims appended hereto.

What is claimed is:

1. A remote control device comprising:
a receiver for wirelessly receiving a signal including a television channel guide;
processing circuitry for processing the received signal to obtain the television channel guide;
a display for displaying the television channel guide; and
input interface for selecting at least one television program listing provided by the television channel guide.

2. The remote control device according to claim 1, wherein the input interface for selecting at least one television program listing includes a directional cursor control mechanism having a device for controlling the position of a cursor on the display and a selection button for selecting the at least one television program listing corresponding to the position of the cursor.

3. The remote control device according to claim 1, wherein the display and input interface for selecting at least one television program listing includes a touch screen that displays the television channel guide and the at least one television program listing is selected by a user touching the at least one television program listing on the touch screen.

4. The remote control device according to claim 1, wherein the signal is received from one of a remote central station, an Internet connected host, and a set top box.

5. The remote control device according to claim 1, wherein the signal includes XML-formatted data.

6. A system for selecting at least one television program listing provided by a television channel guide, said system comprising:
an Internet connected host for transmitting a signal including the television channel guide; and
a remote control device comprising a receiver for receiving the signal including the television channel guide, processing circuitry for processing the received signal to obtain the television channel guide, a display for displaying the television channel guide, and input interface for selecting the at least one television program listing provided by the television channel guide.

7. The system according to claim 6, wherein the Internet connected host connects to a remote server via the Internet to receive the television channel guide.

8. A system for transmitting a television channel guide, said system comprising:
a remote central station for transmitting a signal including the television channel guide, wherein the signal is formatted to be received by a remote control device comprising a receiver for receiving the signal including the television channel guide, processing circuitry for processing the received signal to obtain the television channel guide, and a display for displaying the television channel guide.

9. The system according to claim 8, wherein the remote central station includes Internet connection means for connecting to the Internet and transmitting the signal via the Internet.

10. A remote control device comprising:
a receiver for wirelessly receiving a signal including a list of functions for an electronic appliance;
processing circuitry for processing the received signal to obtain the list of functions;
a display for displaying the list of functions; and
input interface for selecting at least one function from the list of functions.

11. The remote control device according to claim 10, wherein the input interface for selecting at least one function includes a directional cursor control mechanism having a device for controlling the position of a cursor on the display and a selection button for selecting the at least one function corresponding to the position of the cursor.

12. The remote control device according to claim 10, wherein the display and input interface for selecting at least one function includes a touch screen that displays the list of functions and the at least one function is selected by a user touching the at least one function on the touch screen.

13. The remote control device according to claim 10, wherein the signal is received from one of a remote central station, an Internet connected host, and a set top box.

14. The remote control device according to claim 10, wherein the signal contains XML-formatted data.
